(19) United States
(12) Patent Application Publication
(10) Pub. No.: US 2006/0082274 A1
(43) Pub. Date: Apr. 20, 2006

(54) Panel assembly, plasma display panel assembly employing the same, and method of manufacturing plasma display panel assembly

(76) Inventor: Jung-Suk Song, Suwon-si (KR)

Correspondence Address: Robert E. Bushnell;Suite 300, 1522 K Street, N.W., Washington, DC, 20005-1202, US

(21) Appl. No.: 11/250,393

(22) Filed: Oct. 17, 2005

(30) Foreign Application Priority Data
Oct. 19, 2004 (KR) 10-2004-0083500

(51) Int. Cl. H01J 61/52; H01J 17/49

(52) U.S. Cl. 313/46; 313/582

(57) ABSTRACT

A panel assembly, a plasma display device assembly employing the panel assembly, and a method of manufacturing the plasma display device assembly. The panel assembly includes a first panel, a second panel arranged parallel to the first panel, a plurality of discharge electrodes arranged between the first panel and the second panel, a dielectric layer covering the plurality of discharge electrodes, a protective layer arranged on the top of a dielectric layer and a heat conductive medium arranged on and attached to a surface of at least one of the first panel and the second panel, the heat conductive medium being adapted to reduce a temperature difference between a display area in a middle of the at least one of the first panel and the second panel where an image is displayed and a non-display area at edges of the at least one of the first panel and the second panel. Accordingly, the temperature difference between the display area and the non-display area of the at least one of the first panel and the second panel is decreased, and thus, damage to the panel assembly can be reduced.

### CLAIM OF PRIORITY

This application makes reference to, incorporates the same herein, and claims all benefits accruing under 35 U.S.C.§119 from an application for PANEL ASSEMBLY, PLASMA DISPLAY PANEL ASSEMBLY EMPLOYING THE SAME, AND METHOD OF MANUFACTURING PLASMA DISPLAY PANEL ASSEMBLY earlier filed in the Korean Intellectual Property Office on 19 Oct. 2004 and there duly assigned Serial No. 10-2004-0083500.

### BACKGROUND OF THE INVENTION

1. Field of the Invention

The present invention pertains to a plasma display panel assembly and a plasma display device assembly, and more particularly, to a plasma display panel assembly and a plasma display device assembly that prevents damage to a substrate by reducing a temperature difference across the display during aging and a method of manufacturing the plasma display panel assembly.

2. Description of the Related Art

Generally, a plasma display panel (PDP) assembly is a flat display device in which a plurality of discharge electrodes are formed on opposing substrates. The space between the substrates is filled with an electric discharge gas as well as a phosphor fluorescent material. When a predetermined voltage is applied across an electric discharge area between the substrates, ultraviolet rays are generated which then produce visible light.

The PDP assembly includes a panel assembly, which is formed by coupling a front panel to a rear panel, a chassis base adhered to the rear side of the panel assembly, a driving circuit board adhered to the rear side of the chassis base, and a flexible printed cable electrically connecting the driving circuit board to the panel assembly.

The manufacturing process of the PDP assembly begins with the formation of the front panel. A plurality of first discharge electrodes are formed on a front substrate that is part of the front panel. A first dielectric layer is printed to cover the first discharge electrodes. Then, a protective layer is formed on the dielectric layer. The rear panel is formed by forming a second discharge electrode on a rear substrate that is part of the rear panel. The second discharge electrode can be covered with a second dielectric layer. Barrier ribs are formed on a top surface of the second dielectric layer to partition a discharging area, and a phosphor layers including red, green, and blue phosphors are coated on portions of the barrier ribs.

While the front and rear panels formed by these processes are disposed opposite to each other, glass frit is spread along the edges of the panels, and a heat treatment is performed on the panels at an appropriate temperature to seal the panels together. To remove impurities including water from between the panels, the space between the panels is exhausted to a vacuum. Then, the space between the panels is injected with a gas mainly made out of xenon-neon (Xe—Ne) and the panel assembly is separated from an exhaust device. Subsequently, a predetermined voltage is applied to the panel assembly to conduct discharge aging, and then integrated circuit (IC) chips are installed on the panel assembly to completely form the PDP assembly.

Aging is a necessary process step in the making of PDP assemblies. During the aging process of the PDP assembly, a current flows into a tipped-off panel assembly to electrically discharge the panel assembly for an appropriate period of time so that electrical and optical properties of the panel assembly can be stabilized. Japanese Patent Laid-open Publication No. Hei 04-14428 discloses a method of aging by alternately applying rectangular wave voltages to a sustaining electrode and a data electrode and lighting a plasma display panel. Japanese Patent Laid-open Publication No. Hei 03-317625 discloses a method of aging which enables elimination of lighting stain due to aging, dissolution of insulation breakdown of an insulating layer by short duration aging. Japanese Patent Laid-open Publication No. Hei 03-308781 discloses a method of performing aging with low voltage without deterioration of aging effects by generating a difference in levels of aging voltages that is alternately applied to a scan electrode and a sustaining electrode. Japanese Patent Laid-open Publication No. Hei 02-231141 discloses a method of reducing the time required to age without damage to a phosphor layer.

However, during these aging processes, the panel assembly is often damaged. The cause of damage to the panel assembly is an excessive temperature difference between a display area where an image is displayed and a non-display area which is connected to external electrode formed along the edges of the display area. In the panel assembly, while the temperature of the non-display area is about 30° C., the temperature of the display area is about 90° C. Accordingly, the temperature difference at the boundary between the non-display area and the display area is about 60° C., which directly causes damage during the panel assembly, leading to greatly reduced yields during the manufacturing process.

### SUMMARY OF THE INVENTION

It is therefore an object of the present invention to provide an improved design for a plasma display panel assembly.

It is also an object of the present invention to provide an improved design for a plasma display device assembly that uses the plasma display panel assembly.

It is still an object of the present invention to provide a plasma display panel assembly that is less apt to be damaged during the aging process.

It is yet an object of the present invention to provide a plasma display device assembly that is less apt to be damaged during the aging process.

It is further an object of the present invention to provide a plasma display panel assembly that has less of a temperature difference between the display area and the non-display area during the aging process.

It is still an object of the present invention to provide a plasma display device assembly that has less of a temperature difference between the display area and the non-display area during the aging process.

It is yet an object of the present invention to provide a plasma display panel assembly that can be produced by a method where high yield results.

It is further an object of the present invention to provide a plasma display device assembly that can be produced by a method where high yield results.

It is also an object of the present invention to provide a method of making a plasma display panel assembly that achieves high yield by preventing huge temperature contrasts from occurring across the panel during aging.

It is still an object of the present invention to provide a panel assembly which can reduce damage to the panel assembly by decreasing a temperature difference between a display area and a non-display area during aging, a plasma display device assembly employing the panel assembly, and a method of manufacturing of the plasma display device assembly.

These and other objects can be achieved by a panel assembly that includes a first panel, a second panel arranged parallel to the first panel, a plurality of discharge electrodes arranged between the first panel and the second panel, a dielectric layer covering the plurality of discharge electrodes, a protective layer arranged on the top of a dielectric layer and a heat conductive medium arranged on and attached to a surface of at least one of the first panel and the second panel, the heat conductive medium being adapted to reduce a temperature difference between a display area in a middle of the at least one of the first panel and the second panel where an image is displayed and a non-display area at edges of the at least one of the first panel and the second panel. The heat conductive medium can be a transparent material adapted to transfer heat from the display area of high temperature to the non-display area of low temperature.

According to another aspect of the present invention, there is provided a plasma display device assembly that includes a panel assembly including a front panel coupled to a rear panel, a chassis base arranged on the panel assembly, a plurality of driving circuit units arranged on the chassis base and adapted to transmit an electrical signal to an individual electrode in the panel assembly, a case surrounding the panel assembly, the chassis base, and the plurality of driving circuit units and a heat conductive medium arranged on at least one of the front panel and the rear panel and adapted to transfer heat from a display area of the at least one of the panel assembly where an image is displayed to a non-display area of the panel at edges of the panel assembly. The heat conductive medium can be a thin film of transparent material that is adapted to transfer heat.

According to still another aspect of the present invention, there is provided a method of manufacturing a plasma display panel assembly, the method including assembling a front panel and a rear panel individually, combining the front panel and the rear panel together, vacuum-exhausting a space between the front panel and the real panel, attaching a heat conductive medium to at least one of the front panel and the rear panel, and aging the front panel and the rear panel by applying a voltage higher than a rated voltage, the heat conductive medium being adapted to transfer heat from a display area of high temperature in a middle of the at least one of the front panel and the rear panel to a non-display area of relatively low temperature at edges of the at least one of the front panel and the rear panel during the aging.

### BRIEF DESCRIPTION OF THE DRAWINGS

A more complete appreciation of the invention and many of the attendant advantages thereof, will be readily apparent as the same becomes better understood by reference to the following detailed description when considered in conjunction with the accompanying drawings in which like reference symbols indicate the same or similar components, wherein:

FIG. 1 is an exploded perspective view of a plasma display panel assembly;

FIG. 2 is an exploded perspective view of a plasma display device employing the panel assembly of FIG. 1;

FIG. 3 is a diagram schematically illustrating areas of the panel assembly of FIG. 1;

FIG. 4 is a perspective view of a panel assembly according to an embodiment of the present invention;

FIG. 5 is a graph illustrating temperature distribution at different areas of the panel assembly of FIG. 1; and

FIG. 6 is a graph illustrating temperature distribution at the different areas of the panel assembly according to an embodiment of the present invention.

### DETAILED DESCRIPTION OF THE INVENTION

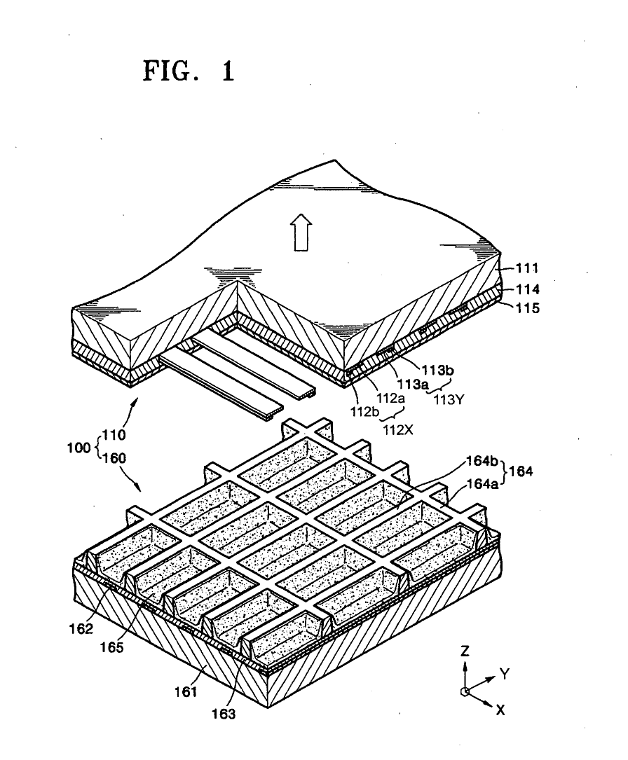

Turning now to the figures, FIG. 1 is an exploded perspective view of a panel assembly 100. Referring to FIG. 1, the panel assembly 100 includes a front panel 110 and a rear panel 160 located opposite to the front panel 110. A front substrate 111 is formed on the front panel 110. The front substrate 111 is a transparent glass substrate such as soda lime glass. X and Y electrodes 112 and 113 respectively are alternately located in discharge cells on a bottom surface of the front substrate 111 along the X-direction of the panel 100.

The X electrode 112 includes first stripe-shaped transparent electrode lines 112a and first bus electrode lines 112b, each overlapping the first transparent electrode line 112a. The Y electrode 113 includes second stripe-shaped transparent electrode lines 113a and second bus electrode lines 113b, each overlapping the second transparent electrode line 113a.

The first and second transparent electrode lines 112a and 113a can be made of transparent conductive films, such as indium tin oxide (ITO), and the first and second bus electrode lines 112b and 113b can be made of silver (Ag) paste that has a high conductivity to reduce electrical resistance along the first and second transparent electrode lines 112a and 113a.

A front dielectric layer 114 covers the X and Y electrodes 112 and 113. The front dielectric layer 114 can selectively coated a portion where the X and Y electrodes 112 and 113 are located. Alternatively, the front dielectric layer 114 can coat the entire area of the front substrate 111. A protective layer 115, such as magnesium oxide (MgO), is then deposited on a surface of the front dielectric layer 114.

A rear substrate 161 makes up part of the rear panel 160 and is oriented to be parallel to the front substrate 111. Stripe-shaped address electrodes 162 are located on the rear substrate 161 along the Y-direction of the panel 100. The address electrodes 162 are located to cross the X and Y electrodes 112 and 113 and extend through discharge cells. A rear dielectric layer 163 covers the address electrode 162.

Barrier ribs 164 are formed between the front and rear panels 110 and 160 and serve to partition a discharge area between the panels into discharge cells and to prevent cross-talk between adjoining discharge cells. The barrier ribs 164 include first barrier ribs 164a extending in the X-direction of the panel 100 and second barrier ribs 164b extending in the Y-direction of the panel 100. The first barrier ribs 164a extend from the inner wall of an adjacent second barrier rib 164b to the outer wall of the next second barrier rib 164b. The first and second barrier ribs 164a and 164b together are arranged in a matrix pattern. Alternatively, the barrier ribs 164 can instead be of a meander-type, a delta type, or a honeycomb shape barrier ribs, and the discharge cells partitioned by the barrier ribs 164 can have polygonal shapes instead of rectangular shapes, or circular shapes, but the shapes of the discharge cells are not limited only to these shapes.

A phosphor layer 165 including red, green, and blue phosphors are coated on sidewalls of the barrier ribs 164 of each discharge cell. The phosphor layer 165 can be coated to any region of the discharge cells, but in the present embodiment, the phosphor layer 165 is coated on sidewalls of the barrier ribs 164. Each of the discharge cells have a phosphor layer 165 present. The red phosphors of the phosphor layer 165 can be made of (Y,Gd)BO₃:Eu⁺³, the green phosphors of the phosphor layer 165 can be made of Zn₂SiO₄:Mn²⁺, and the blue phosphors of the phosphor layer 165 can be made of BaMgAl₁₀O₁₇:Eu²⁺.

The panel assembly 100 with the above structure selects a discharge cell by applying an electrical signal to a Y electrode 13 and another electrical signal to a address electrode 162. When the X and Y electrodes are alternately applied electrical signals, surface discharge occurs on the surface of the front panel 110 so that ultraviolet rays are generated. Visible rays are then emitted from the phosphor layer 165 of the selected discharge cell, and thus a still image or moving pictures can be displayed.

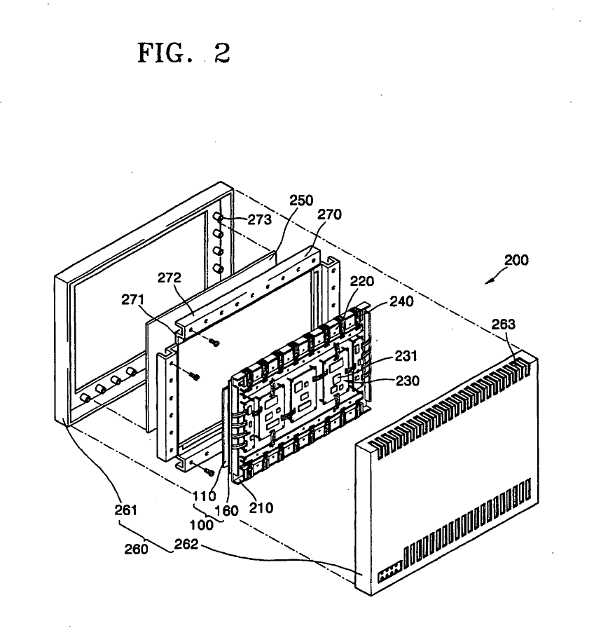

Turning now to FIG. 2, FIG. 2 is an exploded perspective view of a plasma display device assembly 200 employing the panel assembly 100 of FIG. 1. Referring to FIG. 2, the plasma display device assembly 200 includes the panel assembly 100 including the front panel 110 and the rear panel 160 coupled to the front panel 110.

A chassis base 210 is installed on the back of the panel assembly 100. The chassis base 210 is adhered to the panel assembly 100 by an adhesive member. The chassis base 210 is made of an aluminum plate having high thermal conductivity. Chassis reinforcement members 220 are installed on the upper and lower sides of the chassis base 210 to supplement the strength of the chassis base 210.

A plurality of driving circuit units 230 are installed on the back of the chassis base 210. A plurality of circuit elements 231 are mounted on each of the driving circuit units 230. A flexible printed cable 240 is installed between each driving circuit unit 230 and the panel assembly 100. The flexible printed cable 240 electrically connects each electrode terminal of the panel assembly 100 to a connector (not shown) on each driving circuit unit 230.

A filter assembly 250 is installed at a front of the panel assembly 100. The filter assembly 250 blocks electromagnetic waves, infrared rays, or neon radiation produced by the panel assembly 100 and reflects external light.

The panel assembly 100, the chassis base 210, the driving circuit units 230, and the filter assembly 250 are contained in a case 260. The case 260 is made up of a front cabinet 261 installed at the front of the filter assembly 250 and a back cover 262 installed at the back of the driving circuit unit 230. A plurality of vent holes 263 are formed at top and bottom portions of the back cover 262.

A filter holder 270 is installed on the back of the filter assembly 250. The filter holder 270 includes a pressing portion 271 that presses the filter assembly 250 toward the front cabinet 261 and a fixing portion 272 that is bent and protrudes toward the panel assembly 100. A filter installation unit 273 is mounted on the back of the front cabinet 261. The fixing portion 272 of the filter holder 270 aligns with the filter installation unit 273. The filter assembly 250 is fixed to the front cabinet 261 by screws.

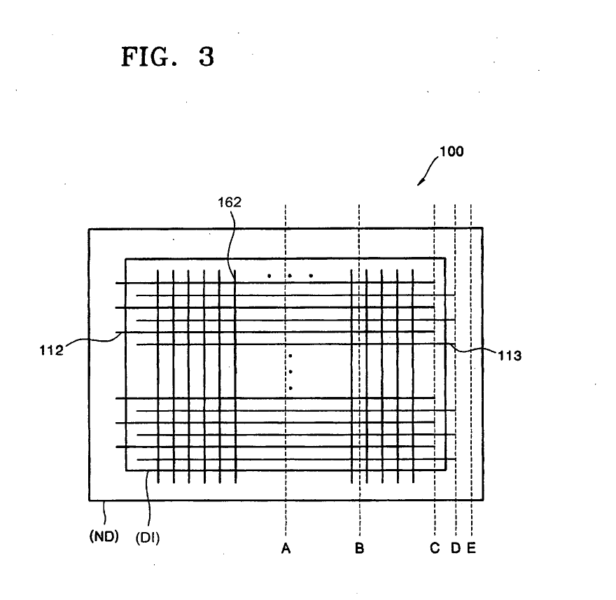

Turning now to FIG. 3, the panel assembly can be divided into the display area DI where images are displayed during driving and the non-display area ND which is formed along the edges of the display area DI and is electrically connected to the external terminals. The X electrodes 112, the Y electrodes 113, and the address electrodes 160 crossing the X and Y electrodes 112 and 113 are located in the display area DI.

When the half of the panel assembly 100 is divided into five portions A, B, C, D, and E as in FIG. 3 in order from the center to the edge of the display, there is a temperature difference between each of the divided portions A, B, C, D, and E due to a high voltage being applied and that is greater than a rated voltage during the aging process. Particularly, a large temperature difference (ΔT=T_{DI}−T_{ND}) occurs between the boundary portions C and D where the display area DI and the non-display area ND contact each other.

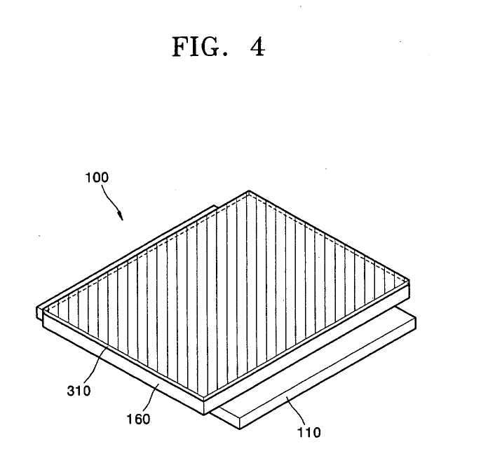

To compensate for this temperature difference in the present invention, a heat conductive medium 310 is installed on the outer surface of the panel assembly 100 as shown in FIG. 4. The heat conductive medium 310 is formed along the outer surface of the rear substrate 160 (surface facing away from the front panel 110), and is made of material with high heat transfer coefficients so that heat produced from the display area DI having a relatively high temperature can easily be transferred to the non-display area ND that is at a relatively low temperature. The heat conductive medium 310 can be made of transparent metal material in order not to affect the image reproducibility.

The heat conductive medium 310 can be formed in various ways, such as by coating the entire surface of the rear substrate 160 with a transparent conductive film, such as an ITO film, or by adhering a either an aluminum film, a copper film, a gold film or platinum film, which have high thermal conductivity, to the entire surface of the rear substrate 160, or by coating the entire surface of the rear substrate 160 using a metal nugget.

The heat conductive medium 310 is formed on the outer surface of the rear substrate 160. The heat conductive medium 310 can also be formed on the outer surface of the front substrate 110, and can instead be formed on both surfaces of the front and rear substrates 110 and 160. When an image is displayed at the front of the front substrate 110, it is advantageous to have the heat conductive medium 310 adhered to the outer surface of the rear substrate 160 so that the image quality is optimized.

When the heat conductive medium 310 is adhered to a surface of the panel assembly 100, a large quantity of heat produced in the display area DI is transferred to the non-display area ND, and consequently, the temperature of the display area DI is lowered and the temperature of the non-display area ND is increased, and thus, the temperature difference between the areas DI and ND can be reduced. By reducing the temperature difference, the panels are less apt to be damaged during aging, and thus the yield is improved.

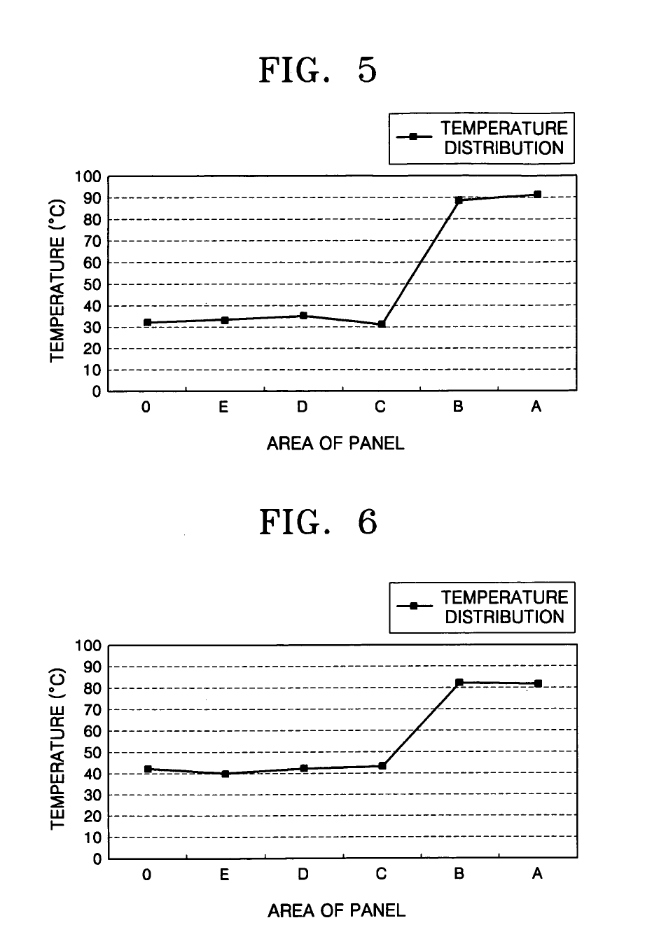

Turning now to FIGS. 5 and 6, FIGS. 5 and 6 empirically show how the design of the present invention, by including the heat conductive medium 310, is superior in reducing temperature differences across the panel. Referring to FIG. 5, FIG. 5 is a comparative example of the panel assembly of FIG. 1 when a heat conductive medium is not formed on an outer surface of the panel assembly. FIG. 6 is a graph illustrating changes in temperature versus location on the panel assembly when the heat conductive medium 310 is formed on the outer surface of the panel assembly according to an embodiment of the present invention. An X-axis of the graphs of FIGS. 5 and 6 represents the five portions A, B, C, D and E of the panel assembly divided from the middle to the edge as shown in FIG. 3, and a Y-axis of FIGS. 5 and 6 represent the temperature (° C.).

Referring to FIG. 5, the temperature rapidly increases to about 90° C. in the inside portions A and B of the display area DI. However, from the boundary portions C and D between the display area DI and non-display area ND to the edge portion E of the panel assembly 100, the temperature is maintained between 30 and 40° C. Referring to FIG. 6, according to the present invention, the temperature increases to about 80° C. in the inside portions A and B of the display area DI. However, from the boundary portion C and D between the display are DI and non-display area ND to the edge portion E of the panel assembly 100, the temperature is maintained at about 40° C.

As described above, in the case of the comparative example of the panel assembly of FIG. 1, the temperature difference (ΔT=T_{DI}−T_{ND}) of FIG. 5 between the display area DI an non-display area ND is about 60° C., while the temperature difference (ΔT=T_{DI}−T_{ND}) of FIG. 6 of the panel assembly according to the present embodiment is about 40° C., and thus the temperature difference ΔT decreases about 30%.

The number of panel assemblies damaged during aging for the display of FIG. 1 and the number of the panel assemblies damaged during aging of the panel display of FIG. 4 according to the present embodiment are as shown in Table 1.

TABLE 1

| | | Number of |
|---|---|---|
| | Total number of | panel assemblies |
| | panel assemblies | damaged during aging |
| Comparative example | 15 | 6 |
| (FIGS. 1 & 5) | | |
| Present Invention | 15 | 1 |
| (FIG. 6) | | |

In the comparative example, although the total number of the panels assembled is 15, the number of the panels damaged during aging is 6 because the temperature difference between the display area DI and the non-display area ND is more than 60° C. On the other hand, in the present embodiment, the total number of the panels assembled is 15, and the number of the panels damaged during aging is only one because the temperature difference between the display area DI and non-display area ND is only 40° C. Thus, by including heat conducting medium in the design of the PDP assembly, the manufacturing yield is improved.

According to an embodiment of the present invention, the process of manufacturing the is plasma display device assembly with the above structure will now be described below. The front substrate 111 made of transparent glass is installed in the front panel 110. The first transparent electrode lines 112a and the second transparent electrode lines 113a are alternately formed on a surface of the front substrate 111. The first bus electrode line 112b and the second bus electrode line 113b are located to overlap an edge of each of the first and second transparent electrode lines 112a and 113a so as to improve the electrical conductivity of the first and second transparent electrode lines 112a and 113a. Subsequently, the front dielectric layer 114 is printed to cover the X and Y electrodes 112 and 113 and the protective layer 115 is deposited over the front dielectric layer 114 to maintain the discharge and to control excessive discharge current.

The rear panel 160 includes the rear substrate 161. The address electrodes 162 are formed on the top surface of the rear substrate 161 in a direction orthogonal to the X and Y electrodes 112 and 113. The rear dielectric layer 163 is printed on the top of the address electrodes 162 to cover them. The matrix type barrier ribs 164 are formed on the top of the rear dielectric layer 163 to partition the discharge cells. The barrier ribs 164 can be formed using a screen print method, a scan blast method, a dry film method, or the like. After forming the barrier ribs 164, the phosphor layer 165 including red, green, and blue phosphors are coated on the barrier ribs 164.

At this time, the heat conductive medium 310 is adhered to the outer surface (the surface facing away from the front substrate 111) of the rear substrate 161. The heat conductive medium 310 can be adhered to the outer surface of the rear substrate 161 when the rear substrate 161 is prepared or after the rear panel 160 is prepared. It is to be appreciated that the adhering can be performed at any time during the course of the manufacturing operations.

After the front and rear panels 110 and 160 are completed, they are assembled together. Specifically, the front and rear panels 110 and 160 are combined and attached to each other, the space between the front and rear panels 110 and 160 is then exhausted and then injected with an electric discharge gas. The front and rear panels 110 and 160 are then aged, and the circuit units are attached to the front and rear panels 110 and 160.

After the front and rear panels 110 and 160 are aligned with each other and fixed together by a fixing member such as a clip, glass frit which is a sealing material is coated along the inner edges of the front and rear panels 110 and 160 located opposite to each other. Then, the assembly undergoes heat treatment at an appropriate temperature, such as 500° C., to seal the front and rear panels 110 and 160 together.

Then, vacuum exhausting and gas injection processes are performed on the front and rear panels 110 and 160. Specifically, air in the panel assembly 100 is exhausted through an individually provided exhaust device at a temperature of at least 300° C. As the result, impurities, including water, that existed inside the panel assembly 100 are removed. After high vacuum is obtained, barium and zirconium getters are activated using a high frequency induction heating method or the like. These getters absorb non-desired gases. The area between the front and rear panels 110 and 160 is then injected with several milligrams of an electric discharge gas, which can be a mixture of xenon, neon, helium and the like into the vacuum and the panel assembly 100 is separated from the exhaust device.

The surface of the protective layer 115 is activated by applying high voltage which is higher than rated voltage to each of the electrodes 112 and 13 of the panel assembly 100, and the panel assembly 100 is aged to stabilize its discharge properties. For example, a voltage between 200 and 300 V at a frequency between 20 and 50 KHz is applied to the panel assembly 100 during aging.

At this time, since the heat conductive medium 310 is made of transparent metal material having a high thermal conductivity and it is installed on the outer surface of the panel assembly 100, the temperature difference between the display area DI and the non-display area ND of the panel assembly 100 is reduced to about 40° C. Accordingly, damage to the panel assembly 100 due to the rapid temperature difference at the boundary of the display area DI and the non-display area ND can be prevented.

After aging, discharging is performed on the panel assembly 100 by applying a predetermined voltage, the getters are cut, and the circuit units are installed in the panel assembly 100, so that the plasma display device assembly 200 is completed.

As described above, according to the present invention, a panel assembly, a plasma display device assembly employing the panel assembly and a method of manufacturing the plasma display device assembly can have following effects. First, during an aging process, a temperature difference between a display area and a non-display area of the panel assembly is reduced, and therefore damage to the panel assembly can be prevented, resulting in higher yield during manufacturing. Second, since the aging is sufficiently performed, discharge voltage and luminance characteristics are improved. Third, a surface of a protective layer is activated and a discharge easily occurs, and accordingly, visible light is sufficiently emitted from a phosphor layer.

While the present invention has been particularly shown and described with reference to exemplary embodiments thereof, it will be understood by those of ordinary skill in the art that various changes in form and details can be made therein without departing from the spirit and scope of the present invention as defined by the following claims.

What is claimed is:

1. A panel assembly, comprising:
a first panel;
a second panel arranged parallel to the first panel;
a plurality of discharge electrodes arranged between the first panel and the second panel;
a dielectric layer covering the plurality of discharge electrodes;
a protective layer arranged on the top of a dielectric layer; and
a heat conductive medium arranged on and attached to a surface of at least one of the first panel and the second panel, the heat conductive medium being adapted to reduce a temperature difference between a display area in a middle of the at least one of the first panel and the second panel where an image is displayed and a non-display area at edges of the at least one of the first panel and the second pane.

2. The panel assembly of claim 1, wherein the heat conductive medium comprises a material adapted to transfer heat from the display area of high temperature to the non-display area of low temperature of the at least one of the first panel and the second panel.

3. The panel assembly of claim 2, wherein the heat conductive medium comprises a transparent conductive film.

4. The panel assembly of claim 2, wherein the heat conductive medium comprises a material selected from the group consisting of copper, aluminum, gold, silver and platinum.

5. The panel assembly of claim 2, wherein the heat conductive medium is of a size sufficient to cover both the display area and non-display area of the at least one of the first panel and the second panel.

6. The panel assembly of claim 1, wherein the protective layer comprises magnesium oxide.

7. A plasma display device assembly, comprising:
a panel assembly including a front panel coupled to a rear panel;
a chassis base arranged on the panel assembly;
a plurality of driving circuit units arranged on the chassis base and adapted to transmit an electrical signal to an individual electrode in the panel assembly;
a case surrounding the panel assembly, the chassis base, and the plurality of driving circuit units; and
a heat conductive medium arranged on at least one of the front panel and the rear panel and adapted to transfer heat from a display area of the panel assembly where an image is displayed to a non-display area of the panel at edges of the panel assembly.

8. The plasma display device assembly of claim 7, wherein the heat conducive medium comprises a thin film of transparent material that is adapted to transfer heat.

9. The plasma display device assembly of claim 8, wherein the heat conductive medium comprises a film selected from the group consisting of an indium tin oxide film, a copper thin film, a silver thin film, a platinum thin film and a gold thin film.

10. The plasma display device assembly of claim 8, wherein the heat conductive medium is arranged between the panel assembly and the chassis base.

11. A method of manufacturing a plasma display panel assembly, the method comprising:
assembling a front panel and a rear panel individually;
combining the front panel and the rear panel together;
vacuum-exhausting a space between the front panel and the real panel;
attaching a heat conductive medium to at least one of the front panel and the rear panel; and
aging the front panel and the rear panel by applying a voltage higher than a rated voltage, the heat conductive medium being adapted to transfer heat from a display area of high temperature in a middle of the at least one of the front panel and the rear panel to a non-display area of relatively low temperature at edges of the at least one of the front panel and the rear panel during the aging.

12. The method of claim 11, wherein the heat conductive medium is attached to cover both the display area and the non-display area of the at least one of the front panel and the rear panel.

13. The method of claim 12, wherein the attaching the heat conductive medium comprises coating the at least one of the front panel and the rear panel with a transparent conductive film having a high thermal conductivity.

14. The method of claim 12, wherein the attaching the heat conductive medium comprises adhering a metal film having a high thermal conductivity to the at least one of the front panel and the rear panel.
